(19) United States
(12) Patent Application Publication
(10) Pub. No.: US 2012/0027889 A1
(43) Pub. Date: Feb. 2, 2012

(54) PROCESS FOR MAKING A COCOA PRODUCT

(75) Inventor: Maria Odila Assumpcão Portella, Ilheus (BR)

(73) Assignee: Cargill Incorporated, Wayzata, MN (US)

(21) Appl. No.: 13/255,979

(22) PCT Filed: Mar. 10, 2010
(86) PCT No.: PCT/US10/26787

§ 371 Date: Sep. 12, 2011

Related U.S. Application Data
(60) Provisional application No. 61/159,292, filed on Mar. 11, 2009.

(51) Int. Cl. A23G 1/42; A23G 1/30

(52) U.S. Cl. 426/45; 426/631

(57) ABSTRACT

Processes for treating cocoa products enzymatically to improve color are disclosed. Aspects of the disclosure are particularly directed to such treatment without changing the pH of the cocoa product.

### CROSS REFERENCE TO RELATED APPLICATION

This application claims the benefit of the U.S. Provisional Patent Application Ser. No. 61/159,292, filed 11 Mar. 2009, entitled PROCESS FOR MAKING A COCOA PRODUCT, which is hereby incorporated by reference in its entirety.

### FIELD

The present disclosure relates generally to a process for treating cocoa products enzymatically to improve color. In some aspects, the disclosure is directed to such treatment without the need for adjusting the pH of the cocoa product.

### BACKGROUND

Cocoa products with darker colors have a wide range of applications in the cocoa and chocolate industry. For instance, cocoa powders with a red, dark brown, or black color are incorporated into a variety of products such as dairy products, cooking ingredients, baking products and confections. Examples of such products include confectionary coatings, compounds, and fillings for candy and chocolate products, chocolates, bars, candy bars, cookies, cocoa and chocolate beverages, instant cocoa products, biscuits, syrups, cakes, breads, puddings, ice cream, ice cream toppings, and other types of desserts. One important use is in chocolates and chocolate bars. Another important use is in the cookie industry, where it is common to have dark sandwich cookies. However, in making many of these cocoa and chocolate products, especially as the intensity of the color increases, there is a tendency to have bitter or off-note flavors.

There are a number of processes used to produce cocoa products such as cocoa cake and cocoa powder from cocoa beans. The traditional process involves fermenting, cleaning and roasting the cocoa beans. Winnowing (also called cracking and fanning) of the hard outer shell of the cocoa beans is done to obtain the cocoa nibs. Grinding of the nibs results in the formation of the cocoa liquor (also called the chocolate liquor, chocolate mass, or cocoa mass). The cocoa liquor is then pressed to separate out the cocoa butter, which is the fat-containing portion, from the cocoa cake, which is the drier portion of the liquor. The cocoa cake is then ground or pulverized and sifted to form the cocoa powder. This traditional process produces a cocoa product that generally has brown color with an L value greater than 19 and is often referred to as cocoa or natural cocoa.

The cocoa beans, nibs, cocoa liquor, cake, or cocoa powder can also be subjected to an alkali that reduces the acidity of the product by the addition of a chemical base and/or a buffer. The alkali process is a well-known step used to raise and modify the pH of the product to produce a darker color in the product. However, it can sometimes lead to the neutralization of the flavor, or create off-notes and flavors. After the alkali process, the pH of the product is often reduced with a buffer and/or acid to the pH range of the original product.

The first step in the treatment of cocoa beans is fermentation, or curing. The cocoa bean (or seed) is removed from the pod, allowed to ferment, and then dried. The fermentation step is important in the development of flavor in the cocoa beans. The cocoa beans are then cleaned and sieved, and may be blended according to certain recipes depending on the end product.

The next step is roasting of the cocoa beans, which is important in producing the flavor and color of the end product. Generally, higher roasting temperatures (as high as 180° C.) will lead to a darker color, whereas lower temperatures (as low as 70° C.) will lead to a lighter color. The roasting step is also important for the development of flavor, as the cocoa product undergoes several chemical reactions to produce nearly 500 flavor compounds that have thus far been identified in them. The traditional method involves roasting of the cocoa beans. In an alternative process, the roasting step can take place on the cocoa nibs or even the cocoa liquor. For example, the cocoa nibs can go through the Dutch process (the alkali process as applied to cocoa nibs) followed by the roasting step.

After roasting, the cocoa beans go through the winnowing step, which consists of removing the shell off the cocoa beans to expose the cocoa nibs. The nibs then go through a grinding step to form the cocoa liquor. Alternatively, the cocoa nibs can be roasted or go through the Dutch process. The cocoa liquor is then pressed, typically by a hydraulic press, to separate the liquor into two different products, a cocoa butter fraction and a cocoa cake fraction. The cocoa butter, which is the liquid fat-containing portion, is used to make sweet and milk chocolates. The cocoa cake, which is the drier portion, is then pulverized and sifted to form the cocoa powder.

A variety of methods currently exist to improve the color of a cocoa product. The most common method used is the alkali process, an alkalization step used on the cocoa beans, nibs, liquor, cake, or powder to make a product with a darker color such as red, dark brown, or black. Common alkaline chemicals used are sodium, calcium, potassium, ammonium, and/or magnesium compounds such as potassium carbonate, sodium hydroxide, ammonium bicarbonate, and/or potassium hydroxide. Sometimes large amounts of these chemicals can produce off-notes or undesirable flavors, and other steps may be necessary to either remove or mask these off-notes. In addition, the alkali process can be run at temperatures ranging anywhere from 60° C. to 230° C. and can generally take from 2 hours to 48 hours. Although the processing time can be reduced by carrying out the process under pressure, the overall process is still time and energy-intensive.

One example of a method for producing a cocoa cake with a dark color is found in U.S. Pat. No. 5,009,917, which uses a modified alkali process. In that process, the cocoa cake is finely sifted, added to an aqueous solution with an initial moisture content of 5-60% and an alkali from 1-12% of the weight of the cocoa, mixed for 5 to 180 minutes at a temperature of 150° to 300° F. (about 66° C.-149° C.) and at a pressure between 10 and 200 p.s.i., venting the reactor and feeding an oxygen-containing gas to effect headspace change in the reactor of at least 3 headspace changes per hour, releasing the pressure, then drying the cake.

Another method for producing a darker color is to increase the time, temperature, and humidity during the roasting step. For instance, it is known that higher roasting temperatures in particular, as well as longer roasting times, can result in a darker color (John Wiley & Sons, Kirk-Othmer Encyclopedia of Chemical Technology, Vo. 6, 356, 2009). Roasting temperatures can vary widely, from 70° C. to 180° C. depending on whether it is a low, medium or high roast. The longer roasting times will lead to a darker color, but may also result in a bitter taste or burnt flavor in the product. Similarly, roasting times can range from 30 minutes to several hours, with longer roasting times leading to darker colors. Higher air humidity conditions and varying the flow rate of air can also be employed during roasting to increase color (Wieslawa Krysiak, J. of Food Eng., 77 (2006), 449-453, Influence of Roasting Conditions on Coloration of Roasted Cocoa Beans). The drawback is that these methods require carefully controlled conditions with relatively high energy usage.

Still other approaches include varying the pH and temperature of cocoa nibs or cocoa liquor in the presence of enzyme treatments in order to obtain a more consistent flavor. For example, in U.S. Pat. No. 5,888,562, the nibs or liquor are prepared from cocoa beans either from different origins or that have been subjected to various stages of fermentation are treated by enzymes as well as changing the pH and temperature followed by roasting in order to overcome the variability in flavor precursors and in order to obtain a flavor of well-fermented and roasted cocoa beans. But in this process the pH is generally adjusted, often several times, along with the temperature, in order to maximize the enzymatic activity to get a more consistent flavor.

Other approaches have been taken to improve the color of cocoa products. Artificial colors can be added to improve the color thereby avoiding having to add chemicals to the product through the alkali process. However, many countries have restrictions on the use of artificial colors in certain food products. Others have used longer times for the alkali process in order to provide for a more intense color of the cocoa product, along with modifying the pH as well as temperature and pressure. Still others have developed extensive processing steps to obtain a darker color without having the bitter flavors or off-notes. However, these processes are time and energy-intensive.

### SUMMARY

The present disclosure relates to a process to produce a treated cocoa product where the process comprises the steps of providing a cocoa product by adding an enzyme mixture of at least one protease and at least one carbohydrase to the cocoa product in the presence of water and treating the cocoa product at a time and at a temperature that is sufficient to increase the reducing sugars and amino acids to obtain a treated cocoa product. In one embodiment the cocoa product that is combined with the enzyme mixture in the presence of water is treated for a time of about 15 minutes to 5 hours and at a temperature between 40° C. and 70° C. The protease that is part of the enzyme mixture typically is selected from the group consisting of endopeptidase, exopeptidase, aminopetidase, metalloproteinase, and carboxypeptidase. The carbohydrase that is part of the enzyme mixture typically is selected from the group consisting of saccharidase, amylase, exo-amylase, beta-amylase, gluco-amylase, endoamylase, alpha-amylase, glucanase, and cellulase. The protease can be in the amount of 0.01 to 1.0% by weight based on the weight of the cocoa product. The carbohydrase can be in the amount of 0.01 to 1.0% weight for weight of the cocoa product. The color of the treated cocoa product has an L value of less than 19. In order to produce a cocoa product with a darker color (e.g., with an L value less than 19), it is necessary to modify the traditional process.

Another aspect of the invention provides a process to produce a treated cocoa product where the process comprises the steps of providing a cocoa product by adding an enzyme mixture of at least one protease and at least one carbohydrase to the cocoa product in the presence of water and treating the cocoa product at a time and at a temperature that is sufficient to increase the reducing sugars and amino acids available for a Maillard reaction to take place without adjusting the pH. These sugars and amino acids are then freely available to react with each other in a nonenzymatic reaction commonly referred to as the Maillard reaction. This reaction is often used to improve the color of the product. In one embodiment, the pH of the cocoa product that has been treated is within a range of plus or minus 1.0 pH unit of the starting cocoa product. In another embodiment, the addition of bases, acids, buffers, or neutralizing agents is in an amount that does not change the pH of the cocoa product or treated cocoa product by more than 0.1 to 1.0 pH units. The pH range of the cocoa product and the treated cocoa product is maintained between a pH of 4.0 to 7.0. In another embodiment the cocoa product that is combined with the enzyme mixture in the presence of water is treated for a time of about 15 minutes to 5 hours and at a temperature of less that 70° C. Typically, the temperature is at least 40° C. The protease that is part of the enzyme mixture can be selected from the group consisting of endopeptidase, exopeptidase, aminopetidase, metalloproteinase, and carboxypeptidase. The carbohydrase that is part of the enzyme mixture can be selected from the group consisting of saccharidase, amylase, exo-amylase, beta-amylase, gluco-amylase, endoamylase, alpha-amylase, glucanase, and cellulase. The protease typically is in the amount of 0.01 to 1.0% by weight based on the weight of the cocoa product. The carbohydrase typically is in the amount of 0.01 to 1.0% by weight based on the weight of the cocoa product. The treated cocoa product has a color with an L value of less than 19.

One aspect of the invention provides for a process for providing a cocoa product that has already been roasted by adding an enzyme mixture of at least one protease and at least one carbohydrase to the roasted cocoa product in the presence of water and treating the roasted cocoa product at a time and at a temperature that is sufficient to increase the reducing sugars and amino acids. These reducing sugars and amino acids are then available for a Maillard reaction to take place. In one embodiment the roasted cocoa product is combined with the enzyme mixture in the presence of water is treated for a time of about 15 minutes to 5 hours and at a temperature of between 40° C. and 70° C. The protease that is part of the enzyme mixture can be selected from the group consisting of endopeptidase, exopeptidase, aminopetidase, metalloproteinase, and carboxypeptidase. The carbohydrase that is part of the enzyme mixture can be selected from the group consisting of saccharidase, amylase, exo-amylase, beta-amylase, gluco-amylase, endoamylase, alpha-amylase, glucanase, and cellulase. The protease typically is in the amount of 0.01 to 1.0% by weight based on the weight of the roasted cocoa product. The carbohydrase typically is in the amount of 0.01 to 1.0% by weight based on the weight of the roasted cocoa product. The color of the treated cocoa product has an L value of less than 19.

There is an increasing demand for darker, more intensely colored chocolate products. For example, there is a need for edible food products such as a cocoa product enzymatically treated by an enzyme mixture of at least one protease and at least one carbohydrase in the presence of water at a time and at a temperature sufficient to increase reducing sugars and amino acids available, with an L value of less than 19; wherein the treated cocoa product is incorporated into an edible food product selected from the group consisting of a dairy product, cooking ingredient, baking product, candy, or confection, and any combinations thereof. In another embodiment the edible food product can be confectionary coatings, compounds, and fillings for candy and chocolate products, chocolates, bars, candy bars, cookies, cocoa and chocolate beverages, instant cocoa products, biscuits, syrups, cakes, breads, puddings, ice cream, ice cream toppings, and other types of desserts.

### BRIEF DESCRIPTION OF THE DRAWINGS

FIG. 1 is a process flow chart for the traditional method for producing cocoa powder and cocoa butter from cocoa beans.

FIG. 2 is a process flow chart for an alternative process that includes the alkali process, which can be done on the nibs (the Dutch process) followed by roasting of the cocoa nibs. The alkali process can also be done on the cocoa cake.

FIG. 3 is a process flow chart of the process of producing cocoa powder from cocoa cake. In this process the alkalization step is shown. However, in order produce natural cocoa, this process typically is run without the alkalization step.

### DETAILED DESCRIPTION AND EXAMPLES

### Selected Definitions

As used herein the following terms shall have the following meanings:

The term “cocoa beans” means the bean or seed that is taken from the pod of the tree. It is the basic raw ingredient that is initially fermented and then further processed to produce a variety of products such as cocoa butter, cocoa powder, and chocolate products.

The term “cocoa nibs” refers to the nib or kernel that is separated from the inedible shell of the cocoa bean.

The term “cocoa liquor” means the resulting product from grinding the cocoa nibs. Cocoa liquor is sometimes called chocolate liquor, chocolate mass, or cocoa mass.

The term “cocoa cake” means the product made from the cocoa liquor by the pressing of the cocoa liquor to produce and separate the cocoa cake, which is the drier portion of the cocoa liquor, from the cocoa butter.

The term “cocoa powder” means the product produced from pulverizing and sifting the cocoa cake.

The term “treated cocoa product” means the product resulting from the enzymatic treatment of the starting cocoa powder or cocoa cake respectively under the conditions described herein.

The term “roasted cocoa product” refers to a cocoa powder or cocoa cake that has been subjected to a roasting step. The roasting step in the traditional cocoa process takes place on the cocoa beans, but in alternate processes can also be applied to the cocoa nibs, cocoa liquor, cocoa cake, or cocoa powder.

The term “cocoa product” means the cocoa cake or cocoa powder, whether treated, untreated, or roasted.

The term “alkali process” or “alkalization step” refers to the process of applying an alkali product or a combination of alkali products to the cocoa nibs, cocoa liquor, cocoa cake, or cocoa powder. The process consists of applying one or more alkali chemical compounds such as sodium, calcium, potassium, ammonium, and/or magnesium compounds, for example, potassium carbonate, sodium hydroxide, ammonium bicarbonate, and/or potassium hydroxide or combinations thereof, in order to provide a darker cocoa or chocolate product. The Dutch process generally refers to the alkali process as applied to cocoa nibs.

The term “protease” refers to any enzyme that begins the protein catabolism by hydrolysis of the peptide bonds linking the amino acids in a polypeptide chain. Proteases are sometimes referred to as proteinases or proteolytic enzymes. Proteases belong to the class of enzymes known as hydrolases because they catalyze the hydrolytic breakdown of various bonds in the presence of water into smaller units such as peptides and amino acids.

The term “carbohydrase” refers to any enzyme that hydrolyses carbohydrates into simple sugars. Because carbohydrases act as a catalyst for the hydrolytic breakdown of the carbohydrate bonds into smaller units such as glucose and sucrose in the presence of water, they are considered hydrolases.

### Overview

As briefly described above, the present invention provides for various processes for enzymatically treating cocoa products such as cocoa powder and cocoa cake. One embodiment relates to a process for providing a cocoa product by adding an enzyme mixture of at least one protease and at least one carbohydrase to the cocoa product in the presence of water and treating the cocoa product at a time and at a temperature that is sufficient to increase the reducing sugars and amino acids. The time for treating the cocoa product typically is from 15 minutes to 5 hours. In one embodiment, the time for treatment typically is from 30 minutes to 60 minutes. Surprisingly, the temperature used in the treatment of the cocoa product can be less than 70°. The temperature is typically at least 40° C. The lower time and temperature conditions can result in significant energy savings as well as a reduced production time. In one aspect, each of the enzymes in the enzyme mixture is used in a ratio of 0.01 to 1.0% by weight based on the weight of the cocoa product.

In another aspect, the cocoa product is enzymatically treated without adjusting the pH. This result is quite unexpected as enzymes have a certain pH range of activity, which has led to the use of processes to adjust the pH in order to improve color, such as with the alkali process. This also leads to a faster and easier process to use than the traditional alkali process or the high roast process. Nor is there a need to use the disclosed process under specific pressures to speed up the process. The current process results in a cocoa product with an improved color that is pleasant tasting.

### Process

The cocoa product is treated with an enzyme mixture of at least one protease and at least one carbohydrase in the presence of water at a time and temperature sufficient to increase the reducing sugars and amino acids available for the Maillard reaction. In one aspect, a cocoa product is treated by the enzyme mixture without adjusting the pH. In another aspect, the process is applied to a cocoa product that has already been roasted.

In one embodiment, the invention provides a process for providing a cocoa product by adding an enzyme mixture of at least one protease and at least one carbohydrase to the cocoa product in the presence of water and treating the cocoa product at a time and at a temperature that is sufficient to increase the reducing sugars and amino acids. In another embodiment the enzyme mixture comprises more than one protease and more than one carbohydrase. In one embodiment, the process provides for treating the cocoa product with an enzyme mixture of at least one protease, at least one carbohydrase, and a polyphenol oxidase (often referred to as a tyrosinase) in the presence of water. In another embodiment, the enzyme mixture comprises at least one protease with a polyphenol oxidase. The enzyme mixture of at least one protease and at least one carbohydrase can be optimized to provide the color desired, such as a reddish color, or darker color such as dark brown or black.

The protease can include any enzyme that begins the protein catabolism by hydrolysis of the peptide bonds linking the amino acids in a polypeptide chain. Proteases are sometimes referred to as proteinases or proteolytic enzymes. Proteases belong to the class of enzymes known as hydrolases because they catalyze the hydrolytic breakdown of various bonds in the presence of water into smaller units such as peptides and amino acids. The process therefore increases the amount of amino acids that are freely available for the Maillard reaction to take place. The protease that is part of the enzyme mixture typically is selected from the group consisting of endopeptidase, exopeptidase, aminopetidase, metalloproteinase, carboxypeptidase and combinations thereof. In one aspect, the protease can be in the amount of 0.01 to 1.0% by weight based on the weight of the cocoa product. In another aspect, the amount of protease that is part of the enzyme mixture typically is in the amount of 0.10 to 1.0% by weight based on the weight of the cocoa product. In one embodiment the proteases can include an aminopeptidase such as Flavourzyme® 1000 L, a metalloproteinase neutral protease such as Neutrase® 0.8 L, and a protease such as Alcalase® 2.4 L FG, all available from Novozymes SA.

The carbohydrase that is part of the enzyme mixture can include any enzyme that hydrolyses carbohydrates into simple sugars such as reducing sugars. Because carbohydrases act as a catalyst for the hydrolytic breakdown of the carbohydrate bonds into smaller units such as glucose and sucrose in the presence of water, they are considered hydrolases. The process therefore increases the amount of reducing sugars that are freely available for the Maillard reaction to take place. In one aspect, the carbohydrase that is part of the enzyme mixture is in the amount of 0.01 to 1.0% by weight based on the weight of the cocoa product. In another aspect, the amount of carbohydrase that is part of the enzyme mixture can be in the amount of 0.10 to 0.40% by weight based on the weight of the cocoa product. The carbohydrase that is part of the enzyme mixture can be selected from the group consisting of saccharidase, amylase, exo-amylase, beta-amylase, gluco-amylase, endoamylase, alpha-amylase, glucanase, cellulose, and combinations thereof. In one embodiment the carbohydrase can include an alpha-amylase such as Fungamyl® 800 L, a gluco-amylase or amyliglucosidase such as Amylase™ AG 300 L, a beta-glucanase such as Viscozyme® L, or a cellulase such as Celluclast® 1.5 L, or combinations thereof, all from Novozymes.

In one embodiment the invention relates to a process for providing a cocoa product by adding an enzyme mixture of at least one protease and at least one carbohydrase to the cocoa product in the presence of water and treating the cocoa product at a time and at a temperature that is sufficient to increase the reducing sugars and amino acids. Water will assist in the hydrolytic breakdown of these compounds into smaller units. Preferably, water is present added in the amount of about 20% to 40% by volume of the cocoa product.

Another aspect of the invention provides a process for preparing a cocoa product by adding an enzyme mixture of at least one protease and at least one carbohydrase to the cocoa product in the presence of water and treating the cocoa product at a time and at a temperature that is sufficient to increase the reducing sugars and amino acids available. In one embodiment, the cocoa product is treated for a time of between 15 minutes and 5 hours. In another embodiment, the cocoa product is treated for a time greater than 15 minutes. In yet another embodiment, the cocoa product is treated for a time of between 30 minutes and 60 minutes.

In one aspect of the invention provides a process for providing a cocoa product by adding an enzyme mixture of at least one protease and at least one carbohydrase to the cocoa product in the presence of water and treating the cocoa product at a time and at a temperature that is sufficient to increase the reducing sugars and amino acids available. In one embodiment, the cocoa product is treated at a temperature of less than 70° C. In another embodiment, the cocoa product is treated at a temperature of between 45° C. and 60° C. In yet another embodiment, the cocoa product is treated at a temperature of between 50° C. and 55° C.

The process of enzymatically treating the proteins and carboydrates present in the cocoa product by use of enzymes such as proteases and carbohydrases causes the proteins to be broken down into smaller units such as amino acids and the carbohydrates to be reduced to smaller units such as reducing sugars or simple sugars. These sugars and amino acids are then freely available to react with each other, in a nonenzymatic reaction commonly referred to as the Maillard reaction. This reaction is often used to obtain a darker colored product. This reaction typically takes place in the presence of heat sufficient to allow the reactions to occur between the sugars and amino acids. This heating step of the Maillard reaction typically occurs at temperatures of between 70° C. and 120° C.

The color of the final product can vary depending on the temperature, time, enzyme mixture used, and the amount of enzymes. In particular, the combination of enzymes mixture and amounts used can be varied to produce darker colors. The color can be measured by a number of scales, such as the Hunter L,a,b color space scale. The L value measures the lightness of a product by using a scale from 100 (for pure white) to 0 (for pure black). The lower the number the more black in terms of lightness. For a cocoa product that does not go through the alkali process or a similar process to obtain a darker color (often referred to as “cocoa” or “natural cocoa”), the typical L value is about 21 to 22. Other parameters can also be used to describe the color, such as the “a”, “b”, and “A/b” scales. The “a” value measures the colors between red and green, with a positive number indicating a red color, a negative number indicating a green color, and a value of 0 indicating gray. The “b” value measures the color spectrum between yellow and blue, with a positive number indicating yellow, a negative number indicating blue, and a value of 0 again indicating gray. Finally, the “A/b” ratio is sometimes also used to indicate the reddish hue of the cocoa product. The higher the “A/b” value, the deeper red the color, with a ration of about 1.25 or higher considered as a commercially viable red color. In one aspect, the color of the treated cocoa product has an L value of less than 19. In another aspect, the color of the treated roasted cocoa product has an L value of less than 19. The color can be measured by the HunterLab ColorQuest® 45/0 spectrophotometer by Hunter Associates Laboratory, Inc.

In one surprising aspect, the invention provides for a process of providing a cocoa product by adding an enzyme mixture of at least one protease and at least one carbohydrase to the cocoa product in the presence of water and treating the cocoa product at a time and at a temperature that is sufficient to increase the reducing sugars and amino acids without adjusting the pH. This result is contrary to common practices such as the traditional alkali process which consists of adding an alkali solution to raise the pH of the product. It has been thought that a more acidic product will lead to off-flavors and an astringent taste from the low pH of the starting product, which would require the pH of the cocoa product to be raised. However, in the present disclosure, it is not necessary to add any chemicals to change the pH of the cocoa product, whether it is a base to raise the pH, a buffer or a neutralizing agent to stabilize the pH, or even an acid to reduce the pH to try to get the pH close to the original pH. The pH range of the cocoa product and the treated cocoa product is maintained at a pH of 4.0 to 7.0 during the treating step, and more commonly the pH is between 4.5 to 6.5 during the treating step, and will remain within that range throughout the process. In one embodiment, the variance in the pH of the starting cocoa product and the final treated cocoa product will be within plus or minus a pH of 1. In another embodiment the pH is between 5.0 and 6.0. In another embodiment the variance in the pH of the starting cocoa product and the final treated cocoa product will be within plus or minus 0.5 pH units.

Another aspect of the invention provides for a process for preparing a cocoa product that has already been roasted, by adding an enzyme mixture of at least one protease and at least one carbohydrase to the roasted cocoa product in the presence of water and treating the roasted cocoa product at a time and at a temperature that is sufficient to increase the reducing sugars and amino acids. This result is rather unexpected, as the roasting step is one that is commonly used by itself to try to improve the color of the cocoa product. However, it has been found that the disclosed process can be used to further improve the color even after roasting. In one embodiment the roasted cocoa product is combined with the enzyme mixture in the presence of water is treated for a time of about 15 minutes to 5 hours and at a temperature of between 40° C. and 70° C. The protease that is part of the enzyme mixture can be selected from the group consisting of endopeptidase, exopeptidase, aminopetidase, metalloproteinase, and carboxypeptidase. The carbohydrase that is part of the enzyme mixture typically is selected from the group consisting of saccharidase, amylase, exo-amylase, beta-amylase, gluco-amylase, endoamylase, alpha-amylase, glucanase, and cellulase. The protease typically is in the amount of 0.01 to 1.0% by weight based on the weight of the roasted cocoa product. The carbohydrase typically is in the amount of 0.01 to 1.0% by weight based on the weight of the roasted cocoa product. The color of the treated roasted cocoa product has an L value of less than 19.

### Products

The treated cocoa products disclosed herein can be used in a number of different edible food products such as foods and beverages. In one aspect the edible food product is comprised of a cocoa product that has been enzymatically treated by an enzyme mixture of at least one protease and at least one carbohydrase in the presence of water at a time and at a temperature sufficient to increase reducing sugars and amino acids without adjusting the pH, that has an L value of less than 19, wherein the treated cocoa product is incorporated into a dairy product, cooking ingredient, baking product, candy, or confection, and any combinations thereof. In another aspect, the treated cocoa product is utilized in confectionary coatings, compounds, and fillings for candy and chocolate products, chocolates, bars, candy bars, cookies, cocoa and chocolate beverages, instant cocoa products, biscuits, syrups, cakes, breads, puddings, ice cream, ice cream toppings, and other types of desserts. In one aspect the treated cocoa product can be used in chocolates and chocolate bars. In another aspect, the treated cocoa product can be used in dark sandwich cookies.

### EXAMPLES

The following table shows the results from providing a 10 kg sample of a cocoa product by adding an enzyme mixture of at least one protease and at least one carbohydrase with water for a sufficient time and temperature to allow the enzymatic activity to occur, specifically, to increase the amount of reducing sugars from the carbohydrates and the amino acids from the proteins available for a Maillard reaction to occur. Surprisingly, in some samples the pH does not have to be adjusted at any time for any of the enzymatically treated cocoa product samples during the process and remains relatively consistent throughout the process. Moreover, results show that the color of the final product is darker as indicated by L values of less than 19 as compared to product that is not enzymatically treated, which typically has an L value of about 21. The temperature of the process is at about 50° C.-55° C. After the cocoa product is enzymatically treated, it is dried by steam at a temperature of 100° C. for about 10 minutes. The improved color is surprising even at this low temperature of treatment given that other processes generally rely on higher temperatures, longer times of reaction, and/or higher pressures in order to maximize the amount of enzymatic activity. The relatively low temperatures and short reaction time results in significant energy savings over conventional process to increase the color of a cocoa product. In addition, because the process can be done with reduced or even no chemicals added to adjust the pH, the result is a treated cocoa product without any off-flavors that can be associated with high amounts of chemical treatment. Unexpectedly, even without raising the pH of the cocoa product to avoid bitter flavors and lighter colors associated with a more acidic product, a darker color can be achieved in the product while retaining a pleasant flavor.

TABLE 1

| | | Time | | |
|---|---|---|---|---|
| | | reaction | | |
| Enzyme Mixture | Dosage % | (hour) | pH | Color (L, A/b) |
| Fungamyl, AG, Flavourzyme and Neutrase | 0.01 to 0.1 | 0.5 to 1 | 5.78 | L = 16.58, A/b = |
| | | | | 1.13 |
| Fungamyl, AG, Flavourzyme and Neutrase | 0.1 to 0.2 | 0.5 to 1 | 5.78 | L = 16.9, A/b = |
| | | | | 1.11 |
| Fungamyl, AG, Flavourzyme, Neutrase, | 0.01 to 0.1 | 0.5 to 1 | 5.8 | L = 16.96, A/b = |
| Celluclast and Viscozyme | | | | 1.12 |
| Fungamyl, AG, Flavourzyme, Neutrase, | 0.1 to 0.1 | 0.5 to 1 | 5.79 | L = 17.1, A/b = |
| Celluclast and Viscozyme | | | | 1.11 |
| Fungamyl, AG, Flavourzyme and Neutrase | 0.01 to 0.2 | 0.5 to 1 | 5.70 | L = 16.07, A/b = |
| | | | | 1.1 |
| Fungamyl, AG, Flavourzyme, Neutrase, | 0.1 to 0.2 | 1 | 5.63 | L = 16.57, A/b = |
| Celluclast and Viscozyme | | | | 1.07 |
| Fungamyl, AG, Flavourzyme and Neutrase | 0.01 to 0.1 | 1 | 5.78 | L = 16.58, A/b = |
| | | | | 1.13 |
| Fungamyl, AG, Flavourzyme and Neutrase | 0.1 to 0.2 | 1 | 5.78 | L = 16.9, A/b = |
| | | | | 1.11 |
| Fungamyl, AG, Flavourzyme, Neutrase, | 0.01 to 0.1 | 1 | 5.80 | L = 16.96, A/b = |
| Celluclast and Viscozyme | | | | 1.12 |
| Fungamyl, AG, Flavourzyme, Neutrase, | 0.1 to 0.2 | 1 | 5.79 | L = 17.1, A/b = |
| Celluclast and Viscozyme | | | | 1.11 |
| Fungamyl, AG, Flavourzyme and Neutrase | 0.2 to 1 | 1 | 5.70 | L = 16.07, A/b = |
| | | | | 1.1 |
| Fungamyl, AG, Flavourzyme, Neutrase, | 0.2 to 1 | 1 | 5.63 | L = 16.57, A/b = |
| Celluclast and Viscozyme | | | | 1.07 |
| Fungamyl, AG, Flavourzyme and Neutrase | 0.3 to 1 | 0.5 | 5.80 | L = 16.46, A/b = |
| | | | | 0.98 |
| Fungamyl, AG, Flavourzyme and Neutrase | 0.3 to 1 | 1 | 5.80 | L = 15.31, A/b = |
| | | | | 0.99 |
| Fungamyl, AG, Flavourzyme, Neutrase, | 0.3 to 1 | 0.5 | 5.80 | L = 16.96, A/b = |
| Celluclast and Viscozyme | | | | 1.00 |
| Fungamyl, AG, Flavourzyme, Neutrase, | 0.3 to 1 | 1 | 5.80 | L = 17.52, A/b = |
| Celluclast and Viscozyme | | | | 0.99 |
| Fungamyl, AG, Flavourzyme and Neutrase | 0.4 to 1 | 0.5 | 5.80 | L = 15.03, A/b = |
| | | | | 1.01 |
| Fungamyl, AG, Flavourzyme and Neutrase | 0.4 to 1 | 1 | 5.80 | L = 15.38, A/b = |
| | | | | 0.99 |
| Fungamyl, AG, Flavourzyme, Neutrase, | 0.4 to 1 | 0.5 | 5.80 | L = 15.77, A/b = |
| Celluclast and Viscozyme | | | | 1.01 |
| Fungamyl, AG, Flavourzyme, Neutrase, | 0.2 to 1 | 1 | 5.80 | L = 17.12, A/b = |
| Celluclast and Viscozyme | | | | 0.99 |
| Fungamyl, AG, Flavourzyme and Neutrase | 0.2 to 1 | 1 | 5.80 | L = 11.87, A/b = |
| | | | | 1.09 |

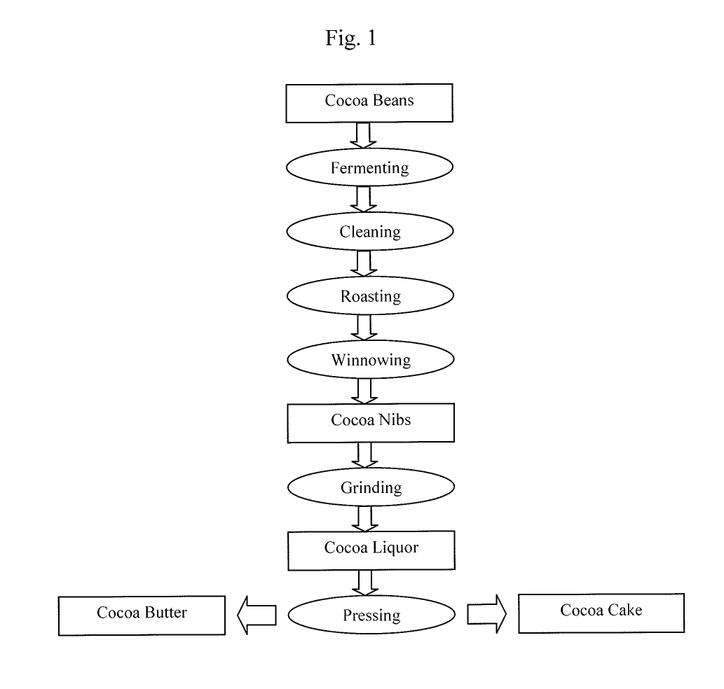

A second set of tests are run on cocoa product samples with 10 kg where even darker colors are obtained via enzymatic treatment. The first run consists of a reference sample where no enzymes are added to the sample and it is treated by the conventional process as detailed in FIG. 1 in order to obtain natural cocoa product. Specifically, the cocoa product is treated via sterilization, dried and roasted but it is not put through the alkali process. This reference sample has the typical brown color as indicated by an L value greater than 19.

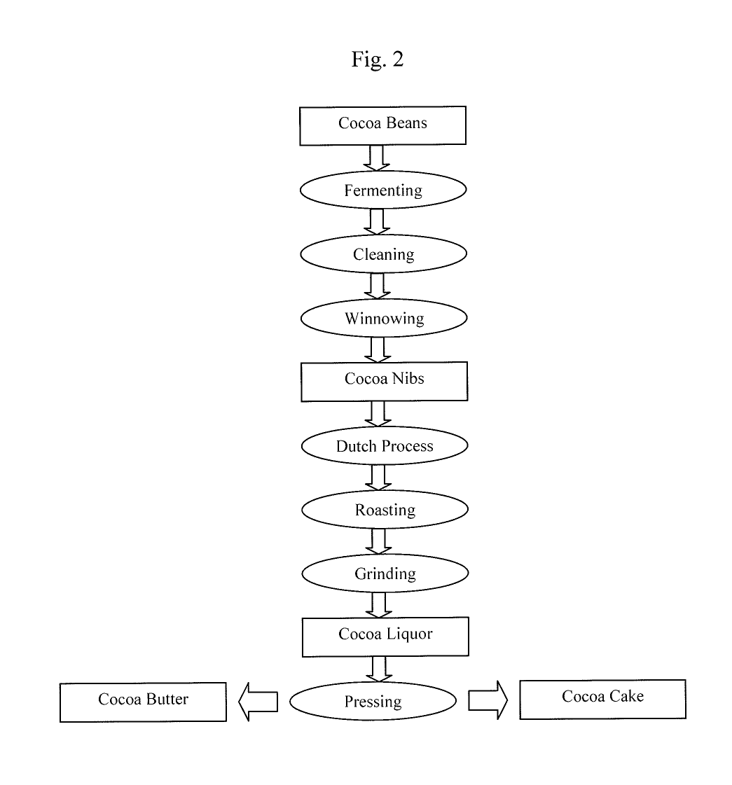

The second run consists of the alternative process detailed in FIG. 2. Alternatively it can include the alkali step of adding an alkali solution. In this instance, the alkali solution typically comprises a 1.0 to 10% solution by volume in water each of potassium carbonate (50% concentration) and sodium hydroxide (30% concentration), at a time of reaction between eight hours and twelve hours, and at a temperature of about 80° C. The resulting pH is about 8.0. In this alkali process sample, a much darker color is obtained as indicated by an L value of about 6.0.

The remaining cocoa samples are treated by adding an enzyme mixture comprising at least one protease and at least one carbohydrase with water at a time and temperature to allow the enzymatic reaction to occur. In these samples, even darker colors are obtained, as can be seen from the L values below 19, ranging from 13.7 to as low as 8.2. Furthermore, no pH changes were necessary in order to obtain higher colors. The pH of these samples is can range from about 5.0 to 6.5.

Further tests are performed by adding an enzyme mixture comprising at least one protease and at least one carbohydrase to the cocoa product with water at a time and temperature sufficient for an enzymatic reaction to occur, and further comprising using a modified alkali process with a reduced amount of alkali. For example, the alkali solutions are less than 20%, ranging from 18% to as low as 1.3%. An example alkali solution to use with the enzymatic treatment is a 13.2% total alkali solution comprising a 3.3% Ammonia solution (12% concentration), a 3.3% Sodium Hydroxide solution (50% concentration), and a 6.6% Potassium Carbonate solution (50% concentration). The pH of the cocoa product sample is about pH 8 to 10. In contrast, an example of a typical alkali solution used in the conventional process typically is 2.5-3.5% of an Ammonia solution (12% concentration) with 15-30% Sodium Hydroxide solution (50% concentration), which is a 17.5-33.5% total alkali solution.

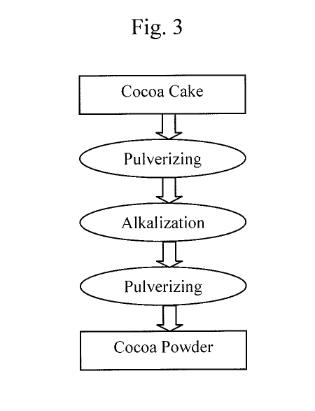

Referring to FIG. 3, which shows the further treatment of the cocoa cake to form a cocoa powder, the enzymatic treatment can be performed at any stage of this process. In one embodiment, the enzymatic treatment typically is done in place of the alkali step to product a treated cocoa product. In a further embodiment the process is done without adjusting the pH of the cocoa product. In another embodiment, a cocoa product that has already been roasted is enzymatically treated to produce a dark cocoa product.

TABLE 2

| Enzyme Mixture | Color L | A | b | A/b |
|---|---|---|---|---|
| Reference sample (no enzymes added) | 20.6 | 8.9 | 7.8 | 1.13 |
| Standard recipe—Alkali process (no enzymes added) | 5.8 | 1.7 | 1.2 | 1.44 |
| AMG, Flavourzyme, Fungamyl and BAN (0.1% each) (30 min) | 13.2 | 7.0 | 5.6 | 1.26 |
| AMG, Flavourzyme, Fungamyl and BAN (0.2% each) (30 min) | 13.5 | 7.1 | 5.7 | 1.26 |
| AMG, Flavourzyme, Fungamyl, BAN, Celluclast and | 13.6 | 7.1 | 5.7 | 1.24 |
| Viscozyme (0.1% each) (30 min) | | | | |
| AMG, Flavourzyme, Fungamyl, BAN, Celluclast and | 13.7 | 7.0 | 5.6 | 1.25 |
| Viscozyme (0.1% each) (30 min) | | | | |
| AMG, Flavourzyme, Fungamyl and BAN (0.1% each) (1 hour) | 13.7 | 7.2 | 5.8 | 1.25 |
| AMG, Flavourzyme, Fungamyl and BAN (0.2% each) + | 14.2 | 7.4 | 5.8 | 1.28 |
| Ammonia solution (2.5%) (1 hour) | | | | |
| AMG, Flavourzyme, Fungamyl and Neutrase (0.1% each) (1 | 11.7 | 5.8 | 4.7 | 1.23 |
| hour) | | | | |
| AMG, Flavourzyme, Fungamyl and Neutrase (0.1% each) + | 12.3 | 5.9 | 5.1 | 1.17 |
| Potassium carbonate (1.3%) (1 hour) | | | | |
| AMG, Flavourzyme, Fungamyl and Neutrase (0.1% each) + | 12.4 | 5.7 | 5.3 | 1.09 |
| Potassium carbonate (2.0%) (1 hour) | | | | |
| AMG, Flavourzyme, Fungamyl, Neutrase, Celluclast and | 11.0 | 5.2 | 4.7 | 1.12 |
| Viscozyme (0.1%/each) + Potassium carbonate (3.0%) + | | | | |
| Ammonia solution (2.2%) (1 hour) | | | | |
| AMG, Flavourzyme, Fungamyl, BAN(0.1% each) + Amonia | 9.7 | 4.2 | 3.2 | 1.29 |
| solution (5%) + NaOH (5%) (1 hour) | | | | |
| AMG, Flavourzyme, Fungamyl and BAN (0.2% each) + | 11.3 | 6.2 | 4.8 | 1.27 |
| Potassium carbonate (5%) (1 hour) | | | | |
| AMG, Flavourzyme, Fungamyl and Neutrase (0.2% each) + | 8.2 | 3.7 | 2.9 | 1.28 |
| Ammonia solution (5%) + Potassium Carbonate (5%) + | | | | |
| NaOH (2.5%) (1 hour) | | | | |
| AMG, Flavourzyme, Fungamyl and Neutrase (0.2% each) + | 6.9 | 2.3 | 1.6 | 1.45 |
| Ammonia solution (5%) + Potassium Carbonate (4%) + | | | | |
| NaOH (2.8%) (1 hour) | | | | |
| AMG, Flavourzyme, Fungamyl, Neutrase, Celluclast and | 5.4 | 2.5 | 1.7 | 1.48 |
| Viscozyme (0.2%/each) + Ammonia solution (5%) + | | | | |
| Potassium Carbonate (5%) + NaOH (5%) (1 hour) | | | | |
| AMG, Flavourzyme, Fungamyl, BAN, Celluclast and | 6.2 | 2.2 | 1.5 | 1.48 |
| Viscozyme—(0.1%/each) + Ammonia solution (6%) + | | | | |
| Potassium Carbonate (6%) + NaOH (3%) (1 hour) | | | | |
| AMG, Flavourzyme, Fungamyl, BAN, Celluclast and | 9.8 | 4.7 | 4.0 | 1.18 |
| Viscozyme (0.1% each) (1 hour) | | | | |
| AMG, Flavourzyme, Fungamyl, Neutrase, Celluclast and | 5.7 | 2.2 | 1.4 | 1.58 |
| Viscozyme (0.2%/each) + Ammonia solution (6%) + | | | | |
| Potassium Carbonate (6%) + NaOH (6%) (1 hour) | | | | |
| AMG, Flavourzyme, Fungamyl, BAN, Celluclast and | 9 | 4.1 | 3.5 | 1.18 |
| Viscozyme (0.2% each) (2 hours) | | | | |
| AMG, Flavourzyme, Fungamyl, BAN, Celluclast and | 7.5 | 2.4 | 1.9 | 1.26 |
| Viscozyme (0.2% each) + Ammonia solution (5%) + | | | | |
| Potassium Carbonate (5%) + NaOH (5%) (1 hour) | | | | |
| AMG, Flavourzyme, Fungamyl, Neutrase, Celluclast and | 8.2 | 3.6 | 3.1 | 1.15 |
| Viscozyme (0.2% each) (1 hour) | | | | |
| AMG, Flavourzyme, Fungamyl, BAN, Celluclast and | 5.2 | 1.76 | 1.48 | 1.19 |
| Viscozyme (0.2%/each) + Ammonia solution (5%) + | | | | |
| Potassium Carbonate (5%) + NaOH (5%) (1 hour) | | | | |

An additional set of tests include results from enzymatically treating a cocoa product with at least one protease and at least one carbohydrase with water for a time and temperature sufficient to increase reducing sugars and amino acids alone and in combination with an alkali process. The cocoa product showed an improved dark color with an L value ranging from 3 to 8.4. Also included are the dosage percentages of each compound used as well as the reaction time.

TABLE 3

| Enzyme Mixture | Color L | A/b |
|---|---|---|
| AMG, Flavourzyme, Fungamyl, Neutrase, Celluclast and | 3.5 | 0.5 |
| Viscozyme (0.15% each) + Ammonia solution (3.3%) + | | |
| Potassium Carbonate (6.6%) + NaOH (3.3%) (1 hour) | | |
| AMG, Flavourzyme, Fungamyl, Neutrase, Celluclast and | 5.3 | 0.9 |
| Viscozyme (0.15%/each) + Ammonia solution (3.3%) + | | |
| Potassium Carbonate (6.6%) + NaOH (3.3%) (1 hour) | | |

1. A process to produce a treated cocoa product, the process comprising the steps of:
a. Providing a cocoa product;
b. Adding an enzyme mixture of at least one protease and at least one carbohydrase to the cocoa product in the presence of water; and
c. Treating the cocoa product at a time and at a temperature sufficient to increase reducing sugars and amino acids.

2. The process of claim 1, wherein the protease in the enzyme mixture is selected from the group consisting of endopeptidase, exopeptidase, aminopetidase, carboxypeptidase, metalloproteinase, and the carbohydrase is selected from the group consisting of saccharidase, amylase, exo-amylase, beta-amylase, gluco-amylase, endoamylase, alpha-amylase, cellulase, and glucanase, and combinations thereof.

3. The process of claim 2, wherein the protease comprises 0.01-1.0% by weight based on weight of the cocoa product, and the carbohydrase comprises 0.01-1.0% by weight based on weight of the cocoa product.

4. The process of claim 3, wherein the cocoa product is treated for a time of 15 minutes to 5 hours and at a temperature of between 40° C. and 70° C.

5. The process of claim 1, wherein the treated cocoa product has an L value of less than 19.

6. The process of claim 1, wherein the enzyme mixture further comprises a polyphenol oxidase.

7. The process of claim 1 wherein the cocoa product is a roasted cocoa product.

8. (canceled)

9. (canceled)

10. A process to produce a treated cocoa product, the process comprising the steps of:
a. Providing a cocoa product;
b. Adding an enzyme mixture of at least one protease and at least one carbohydrase to the cocoa product in the presence of water; and
c. Treating the cocoa product at a time and temperature sufficient to increase the reducing sugars and amino acids without adjusting the pH to obtain a treated cocoa product.

11. The process of claim 10, wherein the pH of the treated cocoa product is within a range of ±1.0 pH units of the pH of the cocoa product and wherein the pH range of the cocoa product and the treated cocoa product is maintained between a pH of 4.0 to 7.0 during the treating step.

12. (canceled)

13. (canceled)

14. The process of claim 10, wherein the cocoa product is treated for a time of 15 minutes to 5 hours and at a temperature of between 40° C. and 70° C.

15. (canceled)

16. (canceled)

17. The process of claim 10, wherein the protease in the enzyme mixture is selected from the group consisting of endopeptidase, exopeptidase, aminopetidase, carboxypeptidase and metalloproteinase, and the carbohydrase is selected from the group consisting of saccharidase, amylase, exo-amylase, beta-amylase, gluco-amylase, endoamylase, alpha-amylase, cellulase, and glucanase, and combinations thereof.

18. The process of claim 10, wherein the protease comprises 0.01-1.0% by weight based on the weight of the cocoa product, and the carbohydrase comprises 0.01-1.0% by weight based on the weight of the cocoa product.

19. The process of claim 10, wherein the treated cocoa product has an L value of less than 19.

20. The process of claim 10, wherein the enzyme mixture further comprises polyphenol oxidase.

21. (canceled)

22. (canceled)

23. (canceled)

24. (canceled)

25. (canceled)

26. (canceled)

27. A process for making a treated cocoa product the process comprising the steps of:
a. Adding an enzyme mixture of at least one protease and at least one carbohydrase to a cocoa product in the presence of water;
b. Treating the cocoa product at a time and at a temperature sufficient to increase reducing sugars and amino acids without adjusting the pH; and
c. Producing a treated cocoa powder with an L value of less than 19.

28. The process of claim 27 wherein the cocoa product is treated for a time of at least 15 minutes and at a temperature of between 40° C. and 70° C.

29. The process of claim 27 wherein the protease in the enzyme mixture is selected from the group consisting of endopeptidase, exopeptidase, aminopetidase, carboxypeptidase, and metalloproteinase, and the carbohydrase is selected from the group consisting of saccharidase, amylase, exo-amylase, beta-amylase, gluco-amylase, endoamylase, alpha-amylase, cellulase, and glucanase, and combinations thereof.

30. An edible food product comprising:
A cocoa product enzymatically treated by an enzyme mixture of at least one protease and at least one carbohydrase in the presence of water at a time and at a temperature sufficient to increase reducing sugars and amino acids available, with an L value of less than 19; wherein the treated cocoa product is incorporated into an edible food product selected from the group consisting of a dairy product, cooking ingredient, baking product, candy, or confection, and any combinations thereof.

31. The edible food product of claim 30, wherein the at least one food product comprises confectionary coatings, compounds, and fillings for candy and chocolate products, chocolates, bars, candy bars, cookies, cocoa and chocolate beverages, instant cocoa products, biscuits, syrups, cakes, breads, puddings, ice cream, ice cream toppings, and other types of desserts.

32. The edible food product of claim 30 wherein the cocoa product is enzymatically treated without adjusting the pH.
